(19) United States
(12) Patent Application Publication
(10) Pub. No.: US 2023/0045258 A1
(43) Pub. Date: Feb. 9, 2023

(54) WEARABLE DEVICE

(71) Applicant: PEGATRON CORPORATION, TAIPEI CITY (TW)

(72) Inventors: Po-Yen Lai, Taipei City (TW); Ping-Hung Lu, Taipei City (TW)

(73) Assignee: PEGATRON CORPORATION, TAIPEI CITY (TW)

(21) Appl. No.: 17/829,125

(22) Filed: May 31, 2022

(30) Foreign Application Priority Data
Aug. 9, 2021 (TW) 110129318

(51) Int. Cl. H01Q 1/27

(52) U.S. Cl. CPC H01Q 1/273

(57) ABSTRACT

Provided is a wearable device including an annular metal shell and a circuit board. The circuit board is disposed in the annular metal shell, and includes a clearance zone and a tracing zone. The clearance zone includes an antenna feeding portion, and the tracing zone includes electronic elements, a metal circuit, and an antenna grounding portion. The antenna feeding portion is coupled to the electronic elements and the metal circuit, and the antenna feeding portion and the antenna grounding portion are coupled to the annular metal shell, such that the antenna feeding portion, the electronic elements, and the metal circuit jointly resonate at a frequency band.

### CROSS-REFERENCE TO RELATED APPLICATION

This application claims the priority benefit of Taiwan applications serial no. 110129318, filed on Aug. 9, 2021. The entirety of the above-mentioned patent application is hereby incorporated by reference herein and made a part of this specification.

### BACKGROUND

### Technical Field

The disclosure relates to a wearable device, particularly to a wearable device with antenna function.

### Description of Related Art

Wearable devices with communication functions like smart watches have gained in popularity these days. However, the shell of the wearable device is usually made of plastic material with better communication performance, which affects the overall appearance of the device. Therefore, to make the product more aesthetically appealing, it is the research goal in this field to produce wearable devices with the metal shell that still have good antenna performance.

### SUMMARY

The present disclosure provides a wearable device with a conductive shell and good antenna performance.

A wearable device of the disclosure includes an annular metal shell and a circuit board. The circuit board is disposed in the annular metal shell and includes a clearance zone and a tracing zone. The clearance zone includes an antenna feeding portion, and the tracing zone includes a plurality of electronic elements, a metal circuit, and an antenna grounding portion. The antenna feeding portion is coupled to the electronic elements and the metal circuit, and the antenna feeding portion and the antenna grounding portion are coupled to the annular metal shell, such that the antenna feeding portion, the electronic elements, and the metal circuit jointly resonate at a frequency band.

Based on the above, the antenna feeding portion and the antenna grounding portion of the wearable device of the disclosure are coupled to the annular metal shell, and the antenna feeding portion is located in the clearance zone. In the disclosure, the circuit board utilizes its own circuit as the antenna radiator and utilizes the annular metal shell as the ground plane to resonate at a frequency band, and achieve good antenna performance.

### BRIEF DESCRIPTION OF THE DRAWING

FIG. 1 is a schematic diagram of a wearable device according to an embodiment of the disclosure.

FIG. 2 is an exploded schematic diagram of the wearable device of FIG. 1.

FIG. 3 is a schematic top view of the wearable device of FIG. 1 in which a screen is seen through.

FIG. 4 is a schematic cross-sectional view of the wearable device of FIG. 1.

### DESCRIPTION OF THE EMBODIMENTS

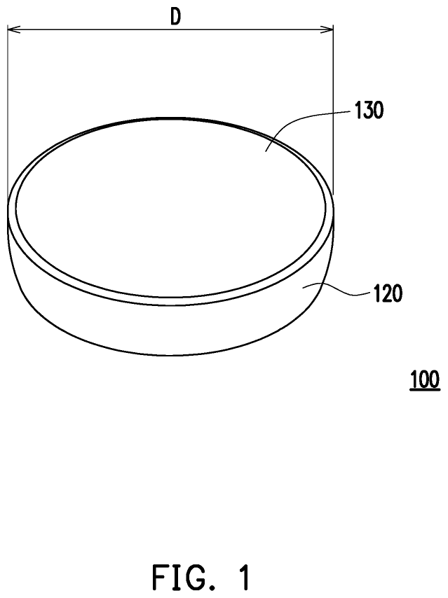

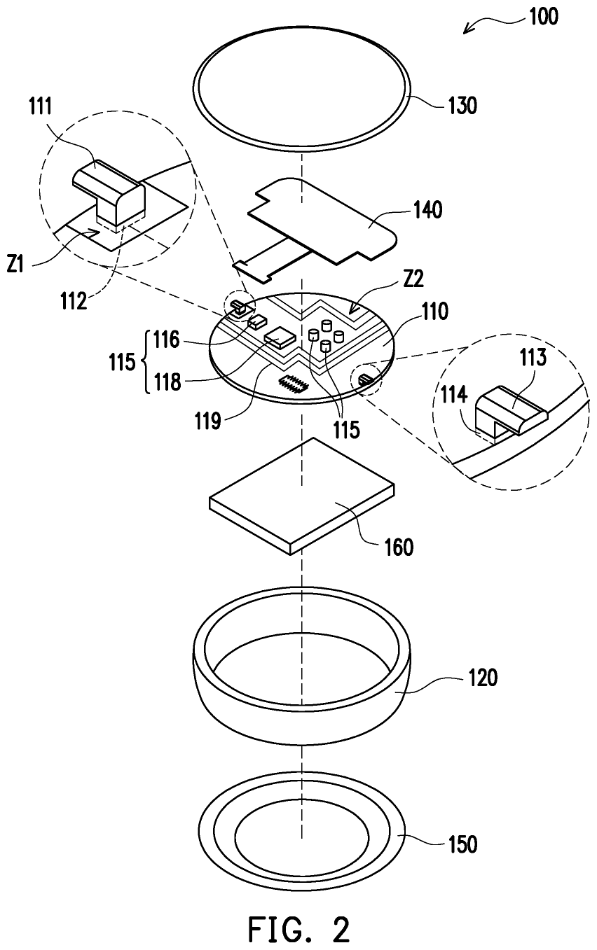

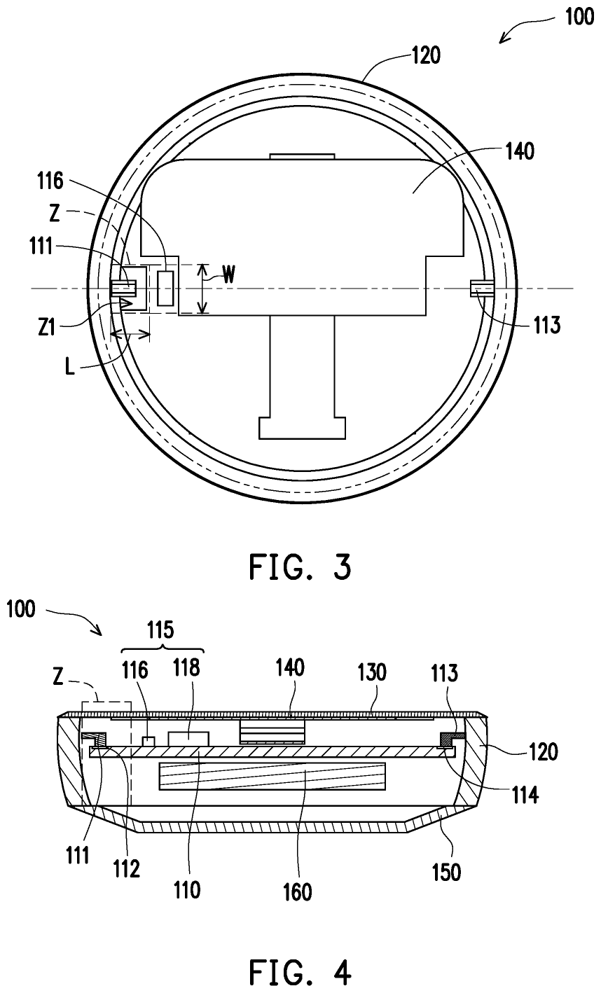

FIG. 1 is a schematic diagram of a wearable device according to an embodiment of the disclosure. FIG. 2 is an exploded schematic diagram of the wearable device of FIG. 1. FIG. 3 is a schematic top view of the wearable device of FIG. 1 in which a screen is seen through. FIG. 4 is a schematic cross-sectional view of the wearable device of FIG. 1. For the simplicity of the drawings, the electronic elements 115 and the metal circuits 119 are only shown in the exploded view of FIG. 2.

Please refer to FIG. 1 and FIG. 4. In this embodiment, the wearable device 100 is, for example, a watch body of a smart watch. However, in other embodiments, the wearable device 100 may also be a head-mounted device or a neck-mounted device, and the types of the wearable device 100 are not limited thereto. The diameter D of the wearable device 100 is between 40 mm and 50 mm, but the shape, length, and width of the wearable device 100 are not limited thereto.

As can be seen from FIG. 2, in this embodiment, the wearable device 100 includes an annular metal shell 120 and a circuit board 110, and the circuit board 110 is disposed in the annular metal shell 120. In this embodiment, the circuit board 110 includes a clearance zone Z1 and a tracing zone Z2. The clearance zone Z1 includes an antenna feeding portion 112. The tracing zone Z2 includes a plurality of electronic elements 115, a metal circuit 119, and an antenna grounding portion 114. The electronic elements 115 are connected to the metal circuits 119 in series or in parallel.

As can be seen from FIG. 4, the antenna feeding portion 112 and the antenna grounding portion 114 are coupled to the annular metal shell 120 respectively through the feeding elastic member 111 and the grounding elastic member 113. In other embodiments, the antenna feeding portion 112 and the antenna grounding portion 114 may also be coupled to the annular metal shell 120 through forms other than elastic members, such as pogo pins, to which the disclosure is not limited.

In this embodiment, the antenna feeding portion 112 and the antenna grounding portion 114 are located away from each other on the circuit board 110, and the antenna grounding portion 114 is connected to the ground plane of the circuit board 110. Specifically, the shape of the circuit board 110 corresponds to the annular metal shell 120, and is approximately circular. Of course, in other embodiments, the shape of the circuit board 110 and the positions of the antenna feeding portion 112 and the antenna grounding portion 114 on the circuit board 110 are not limited thereto.

In this embodiment, there is no antenna pattern on the circuit board 110; instead, the circuit board 110 utilizes its own electronic elements 115 and the traces 119 (see FIG. 2) as the antenna radiator, and utilizes the annular metal shell 120 as the ground plane. Specifically, the antenna feeding portion 112 is coupled to the electronic elements 115 and the metal circuit 119, and the antenna feeding portion 112 and the antenna grounding portion 114 are coupled to the annular metal shell 120, such that the antenna feeding portion 112, the electronic element 115, and the metal circuit 120 jointly resonate at a frequency band. In this embodiment, the wearable device 100 can resonate at a frequency band of 2.4 GHz, for example. The antenna efficiency is tested to be less than −15 dB in the 2.4 GHz frequency band.

In addition, it can be seen from FIG. 3 and FIG. 4 that the wearable device 100 has a three-dimensional clearance zone Z, and the clearance zone Z1 of the circuit board 110 is the projection of the clearance zone Z on the circuit board. In this embodiment, the length L (see FIG. 3) of the clearance zone Z1 is between 3 mm and 5 mm; for example, it may be 4 mm. The width W (see FIG. 3) of the clearance zone Z1 is between 1 mm and 3 mm; for example, it may be 2 mm. That is to say, the area of the clearance zone Z1 is between 3 mm² and 15 mm²; for example, it may be 8 mm².

In a conventional device, to resonate at a frequency band of 2.4 GHz, the size of the antenna clearance range needs to be large. The length of the antenna clearance range needs to be greater than 30 mm, and the width needs to be greater than 20 mm. In this embodiment, the design of using the electronic elements 115 (see FIG. 2) and the metal circuits 119 (see FIG. 2) on the circuit board 110 as antenna radiators and the annular metal shell 120 as the ground plane can significantly reduce the size of the clearance zone Z, and thus can be applied to small devices.

It is worth mentioning that, as it is limited by the intended purposes of the wearable device 100, the size of the annular metal shell 120 may not be adjusted at will, but if there are needs for different operating frequency bands, it can be met by adjusting the position of the antenna feeding portion 112 or the antenna grounding portion 114. For example, the distance between the antenna feeding portion 112 or the antenna grounding portion 114 is set to a certain value (e.g., 40 mm), or ¼ times, ½ times, or full wavelength of the operating frequency band.

In addition, in this embodiment, the electronic elements 115 include an antenna control component 118, such as a radio frequency (RF) module. The antenna control component 118 is coupled to the antenna feeding portion 112 to receive antenna signals. In this embodiment, the tracing zone Z2 of the circuit board 110 further includes a matching element 116, which is electrically connected to the antenna feeding portion 112 and is adapted to adjust the operating frequency band of the wearable device 100. The antenna control component 118 may be electrically connected to the antenna feeding portion 112 through the matching element 116, but it is not limited thereto. For example, the matching element 116 may include a capacitor, resistor, or a combination thereof.

In this embodiment, in order to achieve good antenna matching and good antenna efficiency, the clearance zone Z has no other metal elements. Specifically, in this embodiment, the wearable device 100 further includes a screen 130 and a screen cable 140. The screen 130 is disposed on the upper side of the annular metal shell 120 and covers the circuit board 110. The traces of the screen 130 avoid the clearance zone Z to avoid affecting the antenna matching and the antenna efficiency.

The screen cable 140 is electrically connected to the screen 130 and the circuit board 110, and the screen cable 140 is disposed in the annular metal shell 120, between the circuit board 110 and the screen 130, and outside the clearance zone Z. The projection of the screen cable 140 on the circuit board 110 is located in the tracing zone Z2 (see FIG. 2) to avoid affecting the antenna matching and the antenna efficiency.

In addition, in this embodiment, the wearable device 100 further includes a battery 160, which is electrically connected to the circuit board 110 and is disposed in the annular metal shell 120. The battery 160 is located on the side of the circuit board 110 opposite to the screen 130, and the projection of the battery 160 on the circuit board 110 is located in the tracing zone Z2 to avoid affecting the antenna matching and the antenna efficiency.

Besides, in this embodiment, the wearable device 100 further includes an insulating bottom shell 150. The insulating bottom shell 150 is disposed on the lower side of the annular metal shell 120. The insulating bottom shell 150 and the screen 130 jointly enclose the annular metal shell 120.

Since the insulating bottom shell 150 may directly contact a user's skin when the user wears the wearable device 100, the insulating bottom shell 150 prevents the user from contacting the metal, which could reduce the antenna performance.

In the wearable device 100 of the disclosure, the electronic elements 115 (see FIG. 2) and the metal circuits 119 (see FIG. 2) of the circuit board 110 in the annular metal shell 120 are adapted as the antenna radiator, and no additional antenna patterns are needed, such that the tracing zone of the circuit board 110 may be used effectively. In addition, the annular metal shell 120 is adapted as the ground plane, which is contrary to the conventional configuration of disposing the antenna pattern on the plastic shell or the plastic carrier of the wearable device 100.

Therefore, the wearable device 100 of the disclosure can not only have the texture of a metal shell, but also overcome the conventional need to dispose an antenna pattern in a plastic carrier of a wearable device 100 that results in insufficient internal space of the wearable device 100, reduction of the size of the battery 160, and in turns a reduced battery life. Therefore, the interior space of the wearable device 100 of the disclosure may be utilized with more flexibility.

In summary, the antenna feeding portion and the antenna grounding portion of the wearable device of the disclosure are coupled to the annular metal shell, and the antenna feeding portion is located in the clearance zone. In this disclosure, the circuit board utilized its own electronic elements and metal circuits as the antenna radiator, and utilized the annular metal shell as the ground plane, so as to resonate at a frequency band, and have good antenna performance.

What is claimed is:

1. A wearable device, comprising:
an annular metal shell; and
a circuit board, disposed in the annular metal shell and comprising a clearance zone and a tracing zone, wherein the clearance zone comprises an antenna feeding portion, the tracing zone comprises a plurality of electronic elements, a metal circuit, and an antenna grounding portion, the antenna feeding portion is coupled to the electronic elements and the metal circuit, and the antenna feeding portion and the antenna grounding portion are coupled to the annular metal shell, such that the antenna feeding portion, the electronic elements, and the metal circuit jointly resonate at a frequency band.

2. The wearable device according to claim 1, wherein the antenna feeding portion and the antenna grounding portion are located away from each other on the circuit board.

3. The wearable device according to claim 1, wherein an area of the clearance zone is between 3 mm² and 15 mm².

4. The wearable device according to claim 1, wherein the electronic elements include an antenna control component coupled to the antenna feeding portion.

5. The wearable device according to claim 4, wherein the tracing zone of the circuit board further comprises a matching element electrically connected between the antenna feeding portion and the antenna control component, and the matching element is adapted to adjust the frequency band.

6. The wearable device according to claim 1, further comprising a screen disposed on the annular metal shell and covering the circuit board.

7. The wearable device according to claim 6, further comprising a screen cable disposed in the annular metal shell and located between the circuit board and the screen, wherein a projection of the screen cable on the circuit board is located in the tracing zone.

8. The wearable device according to claim 6, further comprising a battery disposed in the annular metal shell and located on a side of the circuit board opposite to the screen, wherein a projection of the battery on the circuit board is located in the tracing zone.

9. The wearable device according to claim 6, further comprising an insulating bottom shell adapted to enclose the annular metal shell jointly with the screen.

10. The wearable device according to claim 1, wherein the antenna feeding portion is connected to the annular metal shell through a feeding elastic member, and the antenna grounding portion is connected to the annular metal shell through a grounding elastic member.

11. The wearable device according to claim 1, wherein a diameter, a length, or a width of the wearable device is between 40 mm and 50 mm.
